(19) United States
(12) Patent Application Publication
(10) Pub. No.: US 2011/0121930 A1
(43) Pub. Date: May 26, 2011

(54) COIL-BURIED TYPE INDUCTOR AND A METHOD FOR MANUFACTURING THE SAME

(75) Inventors: Katsuyuki TAKEUCHI, Aisai-city (JP); Natsumi Shimogawa, Nagoya-city (JP); Shuichi Ozawa, Nagoya-city (JP)

(73) Assignee: NGK Insulators, Ltd., Nagoya-City (JP)

(21) Appl. No.: 12/884,461

(22) Filed: Sep. 17, 2010

(30) Foreign Application Priority Data
Sep. 24, 2009 (JP) 2009-219611
Sep. 17, 2010 (JP) 2010-208842

(51) Int. Cl. H01F 27/02; H01F 41/04

(52) U.S. Cl. 336/96; 29/602.1

(57) ABSTRACT

The invention relates to a coil-buried type inductor. The inductor comprises a conductive coil, a first fired ceramics body arranged at least in an area along an inner periphery of the coil, and a second fired ceramics body arranged so as to surround the entire of the coil along with the first fired ceramics body. The first fired ceramics body has porosity equal to or larger than 40 percent and smaller than 70 percent.

### FIELD OF THE INVENTION

The present invention relates to a coil-buried type inductor and a method for manufacturing the same.

### BACKGROUND ART

A coil-buried type inductor is described in the Examined Japanese Patent Publication No. 3,248,463. The inductor described herein is constituted by a metallic coil, a resin which coats the coil and a ceramics compact which houses the coil coated by the resin. That is, the inductor described in the Publication is in the form of the coil coated by the resin being buried in the ceramics material. The inductor described in the Publication is manufactured as follows. That is, first, a coil is prepared and a resin coating material is coated on the coil such that the material surrounds the coil. Next, a ceramics slurry is provided around the coil coated by the coating material and then is hardened and thereby an unfired ceramics compact (hereinafter, this unfired ceramics compact will be simply referred to as “ceramics compact”) which has the coil coated by the coating material, is formed. Next, the thus formed ceramics compact is fired and thereby a fired ceramics body after fired (hereinafter, this fired ceramics body after fired will be simply referred to as “fired ceramics body”) is formed. At this time, that is, when the ceramics compact is fired, the coating material which coats the coil is removed by the burning thereof and thereby a cavity is formed between the coil and the fired ceramics body. Next, the fired ceramics body is dipped in an epoxy resin material under vacuum and thereby the epoxy resin material is filled in the cavity formed between the coil and the fired ceramics body. Accordingly, a coil-buried type inductor is manufactured.

When ceramics slurry is provided around the metallic coil and then is hardened and the thus formed ceramics compact is fired, the ceramics compact not a little shrinks. In this regard, the shrinkage of the ceramics compact is inhibited by the coil and therefore cracks may be formed in parts of the fired ceramics body around the coil. In this case, the electrical properties of the inductor constituted by the fired ceramics body may decrease. Of course, even when no crack is formed in the parts of the ceramics compact around the coil, stress may remain in the parts of the fired ceramics body around the coil and the coil by the shrinkage of the ceramics compact. Also, in this case, the electrical properties of the inductor constituted by the fired ceramics body may decrease. In any event, when the shrinkage of the ceramics compact is inhibited, the electrical properties of the inductor constituted by the fired ceramics body may decrease.

On the other hand, in the inductor described in the above-mentioned Publication, when the ceramics compact is fired, the coating material which coats the coil is removed and then the cavity is formed between the coil and the fired ceramics body and therefore the shrinkage of the ceramics compact is not inhibited by the coil. Thus, no crack is formed in the parts of the fired ceramics body around the coil and no stress remains in the parts and the coil. Therefore, the electrical properties of the inductor constituted by the fired ceramics body are favorable.

As explained above, in order to make a coil-buried type inductor have favorable electrical properties when the inductor is manufactured, it is necessary to prevent cracks from being formed in the parts of the fired ceramics body around the coil or to prevent stress from remaining in the parts and the coil when a ceramics compact is fired. Further, as explained above, in the inductor described in the above-mentioned Publication, cracks are prevented from being formed in the parts of the fired ceramics body around the coil or stress is prevented from remaining in the parts and the coil by forming the cavity between the coil and the fired ceramics body when the ceramics compact is fired.

### SUMMARY OF THE INVENTION

### Problem to be Solved by the Invention

In the above-mentioned Publication, in order to prevent the cracks from being formed in the parts of the fired ceramics body around the coil or to prevent the stress from remaining in the parts and the coil, it is necessary to form the cavity between the coil and the fired ceramics body when the ceramics compact is fired. In the Publication, this is accomplished by coating the coil by the coating material which will be removed when the ceramics compact is fired. However, according to this, it is necessary to coat the coil by the coating material and it is necessary to fill the cavity formed between the coil and the fired ceramics body with the resin. Accordingly, the process of manufacturing an inductor is complicated.

Considering this situation, the object of the present invention is to provide a coil-buried type inductor having desired electrical properties which can be manufactured by a simple manufacturing process and to provide a method for manufacturing the same.

### Means for Solving the Problem

According to the first invention of this application, there is provided a coil-buried type inductor, comprising:

a conductive coil;

a first fired ceramics body arranged in an area surrounding the coil and at least along an inner periphery of the coil; and

a second fired ceramics body arranged so as to surround the entire of the coil along with the first fired ceramics body; and

wherein the first fired ceramics body has porosity equal to or larger than 40 percent and smaller than 70 percent.

According to the second invention of this application, in the first invention, wherein the porosity of the first fired ceramics body is larger than that of the second fired ceramics body.

According to the third invention of this application, in the first invention, wherein the first fired ceramics body is arranged in the entire of the area defined by the inner periphery of the coil.

According to the fourth invention of this application, in the first invention, wherein a fluid material is applied on an outer wall surface of the second fired ceramics body and the porosity of the second fired ceramics body is such that the fluid material cannot penetrate into an interior of the second fired ceramics body.

According to the fifth invention of this application, in the first invention, wherein the transverse cross sectional shape of the coil is generally rectangular.

According to the sixth invention of this application, there is provided a method for manufacturing a coil-buried type inductor comprising a conductive coil, a first fired ceramics body arranged in an area surrounding the coil and at least along an inner periphery of the coil and a second fired ceramics body arranged so as to surround the entire of the coil along with the first fired ceramics body,

wherein the method comprises:

a step of preparing a conductive coil;

a step of arranging a first ceramics slurry in the area surrounding the coil and at least along the inner periphery of the coil, the first ceramics slurry including, as the main component, ceramics powders of predetermined grain diameter, and hardening the first ceramics slurry to form a first ceramics compact;

a step of arranging a second ceramics slurry so as to surround the entire of the coil along with the first ceramic compact, the second ceramics slurry including, as the main component, ceramics powders of the grain diameter smaller than that of the ceramics powders constituting the first ceramics slurry; and

a step of firing the first and second slurries to form the first and second fired ceramics bodies, respectively.

According to the seventh invention of this application, in the sixth invention, wherein at the step of arranging the first ceramics slurry in the area along the inner periphery of the coil, the first ceramics slurry is arranged in the entire of the area defined by the inner periphery of the coil.

According to the eighth invention of this application, in the sixth invention, wherein the step of preparing the coil includes a step of preparing the coil which has wound portions which are wound at a pitch larger than a predetermined value;

wherein the method further comprises:

a step of hardening a third ceramics slurry to form two plate-like ceramics compacts, the third ceramics slurry including, as the main component, ceramics powders of the grain diameter smaller than that of the ceramics powders constituting the first ceramics slurry; and

a step of positioning the coil along with the first ceramics compact and the second ceramics slurry between the two plate-like ceramics compacts and pressing the coil along with the first ceramics compact and the second ceramics slurry in the direction parallel to the central axis of the coil such that the pitch between the adjacent wound portions becomes the predetermined value after the step of arranging the second ceramics slurry so as to surround the entire of the coil along with the first ceramics compact and before the step of forming the first and second fired ceramics bodies; and

wherein the step of forming the first and second fired ceramics bodies includes a step of firing the two plate-like ceramics compacts to form third fired ceramics bodies.

According to the ninth invention of this application, in the sixth invention, wherein the method further comprises a step of applying a fluid material on the outer wall surface of the second fired ceramics body, and wherein the second ceramics slurry is a ceramics slurry which includes, as the main component, ceramics powders of the grain diameter producing the porosity of the second fired body such that the fluid material cannot penetrate into the interior of the second fired ceramics body.

According to the tenth invention of this application, in the ninth invention, wherein the method further comprises a step of applying a fluid material on the outer wall surfaces of the third fired ceramics bodies; and wherein the ceramics slurry used to form the two plate-like ceramics compacts is a ceramics slurry which includes, as the main component, ceramics powders of the grain diameter producing the porosity of the third fired ceramics bodies equal to that of the second fired ceramics body.

According to the eleventh invention, in the sixth invention, wherein the transverse cross sectional shape of the coil is generally rectangular.

According to the first invention of this application, the first fired ceramics body arranged in the area along the inner periphery of the coil has a relatively large porosity and therefore when the first fired ceramics body is formed by firing a ceramics slurry, the occurrence of the crack in the first fired ceramics body is restricted even when the shrinkage of the ceramics slurry is inhibited by the coil. That is, unlike the above-mentioned Publication, it is not necessary to fill the cavity formed between the coil and the fired ceramics body after the ceramics slurry in the condition that the coating material coats on the coil, is fired. Therefore, according to the present invention, the coil-buried type inductor having the desired electrical properties which can be manufactured by a simple manufacturing process, can be provided.

Further, according to the second invention of this application, since the porosity of the first fired ceramics body is larger than that of the second fired ceramics body, the coil-buried type inductor having the desired electrical properties can be provided, which inductor comprises the conductive coil, the first fired ceramics body arranged in the area surrounding the coil and at least along the inner periphery of the coil, and the second fired ceramics body arranged so as to surround the entire of the coil along with the first fired ceramics body.

Further, according to the fourth invention of this application, the fluid material is applied on the outer wall surface of the second fired ceramics body. In this regard, when the fluid material penetrates into the interior of the second fired ceramics body and then reaches the coil through the first fired ceramics body, the desired electrical properties of the coil-buried type inductor cannot be obtained due to the fluid material. On the other hand, according to the present invention, the porosity of the second fired ceramics body is such that the fluid material cannot penetrate into the interior of the second fired ceramics body. Therefore, even when the fluid material is applied on the outer wall surface of the second ceramics body, the fluid material cannot reach the first ceramic fired body through the second ceramics body. Thus, the fluid material cannot reach the coil. Therefore, according to the present invention, even when the fluid material is applied on the outer wall surface of the second fired ceramics body, the coil-buried type inductor having the desired electrical properties can be provided.

Further, according to the fifth invention of this application, the transverse cross sectional shape of the coil is generally rectangular. In the case that the coil which has the rectangular transverse cross sectional shape is employed as the coil for the coil-buried type inductor, the length of the coil-buried type inductor measured in the direction parallel to the central axis of the coil can be shortened, compared with the case that the coil which has the circular transverse cross sectional shape is employed. That is, the thickness of the coil-buried type inductor can be decreased.

Further, according to the sixth invention of this application, the grain diameter of the ceramics powders constituting the main component of the first ceramics slurry arranged in the area along the inner periphery of the coil, is larger than that constituting the main component of the second ceramics slurry arranged so as to surround the entire of the coil along with the first fired ceramics body formed by firing the first ceramics slurry. Therefore, when the first ceramics slurry is fired, the occurrence of the cracks in the first fired ceramics body is restricted even when the shrinkage of the first ceramics slurry is inhibited by the coil. That is, unlike the above-mentioned Publication, it is not necessary to fill the cavity formed between the coil and the fired ceramics body with the resin after the ceramics slurry is fired in the condition that the coating material coats the coil. Therefore, according to the present invention, there is provided the manufacturing method for manufacturing the coil-buried type inductor which has the desired electrical properties by the simple manufacturing process.

Further, according to the eighth invention of this application, the coil is pressed by the two plate-like ceramics compacts in the direction parallel to the central axis of the coil such that the pitch between the adjacent wound portions of the coil becomes the predetermined value. Therefore, the pitch between the adjacent wound portions of the coil can be made the predetermined value by the relatively simple process. Furthermore, the conditions of the two plate-like ceramics compacts preliminarily accurately molded in the desired dimensions can be maintained. Therefore, the distance between the end surface of the coil (that is, the surface defined by the wound portion forming the end of the coil in the direction parallel to the central axis of the coil) and the outer wall surface of the coil-buried type inductor adjacent to the end surface of the coil can be made the desired predetermined value by the relatively simple process such as by pressing the coil by the two plate-like ceramics compacts in the direction parallel to the central axis of the coil such that the pitch between the adjacent wound portions of the coil becomes the predetermined value.

Further, according to the ninth invention, the fluid material is applied on the outer wall surface of the second fired ceramics body. In this regard, when the fluid material penetrates into the interior of the second fired ceramics body and then reaches the coil through the first fired ceramics body, the desired electrical properties of the coil-buried type inductor cannot be obtained due to the fluid material. On the other hand, according to the present invention, the second ceramics slurry is the ceramics slurry which includes, as the main component, the ceramics powders of the grain diameter producing the porosity of the second fired ceramics body such that the fluid material cannot penetrate into the interior of the second fired ceramics body. Therefore, even when the fluid material is applied on the outer wall surface of the second fired ceramics body, the fluid material cannot reach the first fired ceramics body through the second fired ceramics body. Thus, according to the present invention, there is provided the manufacturing method for manufacturing the coil-buried type inductor which has the desired electrical properties even when the fluid material is applied on the outer wall surface of the second fired ceramics body.

Further, according to the tenth invention of this application, the fluid material is applied on the outer wall surfaces of the third fired ceramics bodies. In this regard, in the case that the thickness of the second fired ceramics body arranged between the first and third fired ceramics bodies is extremely small, the fluid material may penetrate into the interior of the third fired ceramics bodies and then reach the first fired ceramics body through the second fired ceramics body. Since the porosity of the first fired ceramics body is relatively large, the fluid material which reaches the first fired ceramics body, may reach the coil through the first fired ceramics body. In this case, the desired electrical properties of the coil-buried type inductor cannot be obtained due to the fluid material. On the other hand, according to the present invention, the porosity of the third fired ceramics bodies is equal to that of the second fired ceramics body. That is, for the ceramics slurry which forms the two plate-like ceramics compacts which will become third fired ceramics bodies, the ceramics slurry which includes, as the main component, the ceramics powders of the grain diameter producing the porosity such that the fluid material cannot penetrate into the interior of the third fired ceramics bodies, is used. Therefore, even when the fluid material is applied on the outer wall surfaces of the third fired ceramics bodies, the fluid material cannot finally reach the first fired ceramics body through the third fired ceramics bodies. Thus, according to the present invention, there is provided the manufacturing method for manufacturing the coil-buried type inductor which has the desired electrical properties, even when the fluid material is applied on the outer surfaces of the third fired ceramics bodies.

### BRIEF DESCRIPTION OF THE DRAWINGS

FIG. 1 is a perspective view of the inductor of the embodiment according to the present invention;

FIG. 2 is a cross sectional view along the line II-II of FIG. 1;

FIG. 3 is a perspective view showing the coil of the inductor of the embodiment according to the present invention;

FIG. 4 is a side view showing the coil of the inductor of the embodiment according to the present invention;

FIG. 5 is a cross sectional view showing the wound portions of the coil of the inductor of the embodiment according to the present invention;

FIG. 6 is a cross sectional view showing the part adjacent to the inner periphery of the wound portions of the coil of the inductor of the embodiment according to the present invention;

FIG. 7 is a side view showing the coil used to form the coil of the inductor of the embodiment according to the present invention;

FIG. 8 is a view for explaining the method for manufacturing the inductor of the embodiment according to the invention;

FIG. 9 is a perspective view showing the shaping molds used in the manufacturing method according to the present invention;

FIG. 10 is a view showing a part of the steps of the manufacturing method according to the present invention;

FIG. 11 is a view for explaining the method for manufacturing the inductor of the embodiment according to the present invention;

FIG. 12 is a view for explaining the method for manufacturing the inductor of the embodiment according to the present invention;

FIG. 13 is a view for explaining the method for manufacturing the inductor of the embodiment according to the present invention; and

FIG. 14 is a view showing the flowchart of the steps of an example of the method for manufacturing the coil-buried type inductor according to the present invention.

### MODE FOR CARRYING OUT THE INVENTION

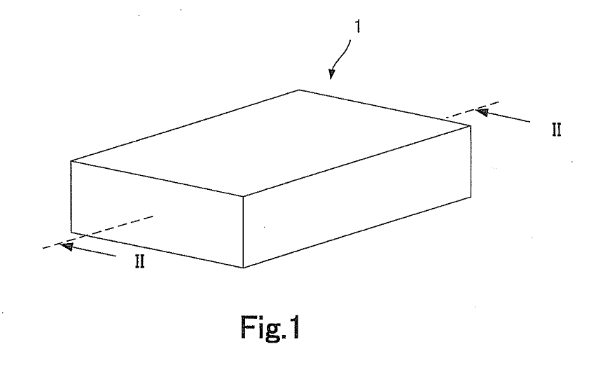

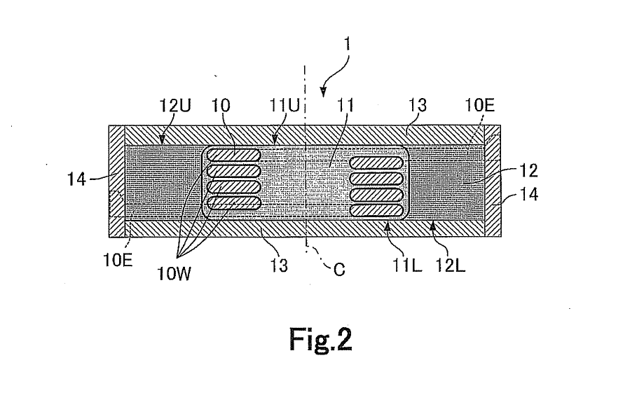

Below, the embodiment according to the present invention will be explained with referring to the drawings. In FIGS. 1 and 2, the coil-buried type inductor of the embodiment according to the present invention is shown. FIG. 1 is a perspective view of the coil-buried type inductor and FIG. 2 is a longitudinal sectional view of the coil-buried type inductor. In FIGS. 1 and 2, reference number 1 denotes the coil-buried type inductor, 10 denotes a coil, 11 denotes a first fired ceramics body, 12 denotes a second fired ceramics body, 13 denotes third fired ceramics bodies and 14 denotes outer electrode layers.

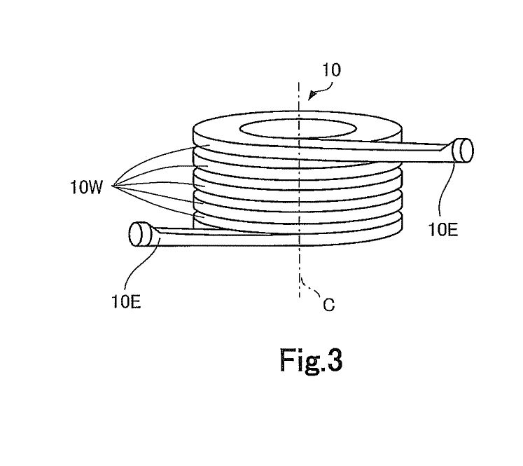

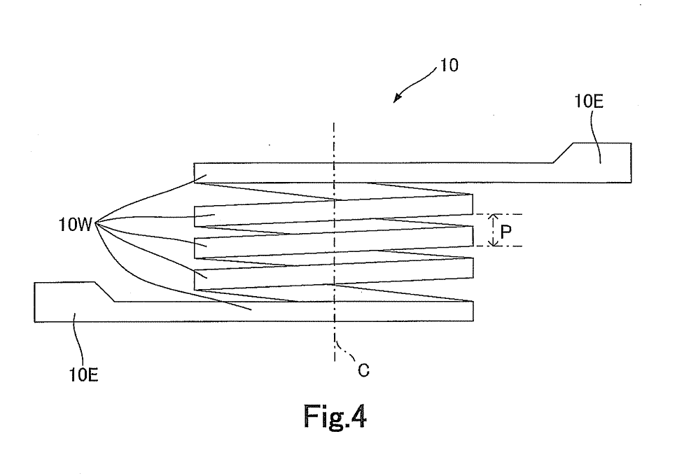

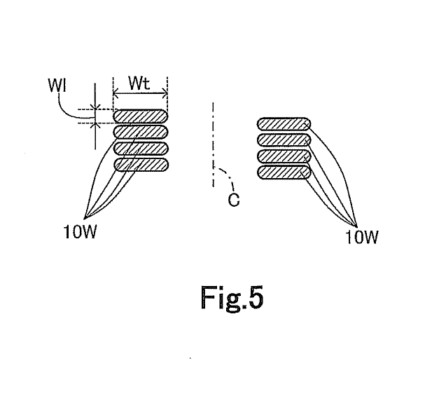

As shown in FIGS. 3 and 4, the coil 10 is a coil constituted by a wire material which is wound (turned) helically at a constant pitch P. Further, as can be understood from FIG. 2, the transverse cross sectional shape of the wire material which constitutes the coil 10 except the end portions 10E of the wire material of the coil 10, is generally rectangular and the transverse cross sectional shape of each end 10E of the wire material of the coil 10 is generally circle. It should be noted that in the following explanations, the end 10E of the coil 10 will be referred to as “end portion” and the portions except the end portions 10E of the coil 10 will be referred to as “wound portions”. Furthermore, as can be understood from FIG. 5, the width Wt (hereinafter, this width Wt will be referred to as “transverse width”) of each wound portion 10W of the coil 10 measured in the direction generally perpendicular to the central axis C of the wound portions 10W of the coil 10 (hereinafter, the central axis of the wound portions will be simply referred to as “central axis”) is larger than the width W1 of each wound portion 10W of the coil 10 measured in the direction parallel to the central axis C of the coil 10 (hereinafter, the width W1 will be referred to as “longitudinal width”), preferably, is equal to or larger than 1.2 times, further preferably, is equal to or larger than 2.0 times, further preferably, is equal to or larger than 6.0 times as large as the longitudinal width W1 of each wound portion 10W of the coil 10. Further, the coil 10 is formed by the conductive wire made of, for example, conductive metal such as silver (Ag), copper (Cu), platinum (Pt) and gold (Au) or made of alloy which includes at least one of the conductive metals such as silver, copper, platinum and gold.

The first fired ceramics body 11 is arranged so as to surround the generally entire of the coil 10 along with the generally cylindrical space defined by the wound portions 10W of the coil 10 in the inner periphery side thereof. Therefore, the first fired ceramics body 11 has a generally cylindrical shape which has a central axis parallel to the central axis C of the coil 10. Further, the first fired ceramics body 11 is formed by firing ceramics slurry which includes, as the main component, ceramics powders of predetermined grain diameter producing predetermined porosity.

The second fired ceramics body 12 is arranged so as to surround the first fired ceramics body 11. Further, the second fired ceramics body 12 has a generally parallelepiped shape. Further, the second fired ceramics body 12 is formed by firing ceramics slurry which includes, as the main component, ceramics powders of predetermined grain diameter producing predetermined porosity.

It should be noted that the porosity of the first fired ceramics body 11 is larger than that of the second fired ceramics body 12.

Further, the porosity of the first fired ceramics body 11 is equal to or larger than 40 percent and equal to or smaller than 60 percent, preferably, is equal to or larger than 40 percent and equal to or smaller than 50 percent. On the other hand, the porosity of the second fired ceramics body 12 is equal to or larger than 2 percent and equal to or smaller than 16 percent, preferably, is equal to or larger than 2 percent and equal to or smaller than 10 percent. It should be noted that the porosity means a ratio of the area of the pores calculated by the imaging process on the basis of the ground section of the fired body.

Further, the end portions 10E of the wire of the coil 10 extend in the direction generally perpendicular to the central axis C of the coil 10 and protrude from the opposite outer wall surfaces of the second fired ceramics bodies 12, which outer wall surfaces extend parallel to the central axis C of the coil 10.

One of the third fired ceramics bodies 13 is arranged so as to cover the outer wall surface 12U of the second fired ceramics body 12, which outer wall surface 12U extends in the direction perpendicular to the central axis C of the coil 10 and is positioned at the upper side of the coil 10 in FIG. 2 (hereinafter, the outer wall surface 12U will be referred to as “upper outer wall surface”). Further, the other third fired ceramics body 13 is arranged so as to cover the outer wall surface 12L of the second fired ceramics body 12, which outer wall surface 12L extends in the direction perpendicular to the central axis C of the coil 10 and is positioned at the lower side of the coil 10 in FIG. 2 (hereinafter, the outer wall surface 12L will be referred to as “lower outer wall surface”). Further, each third fired ceramics body 13 has generally rectangular parallelepiped plate-like shape which has a relatively small thickness. Further, the third fired ceramics bodies 13 are formed by firing ceramics slurry which includes as the main component, ceramics powders of predetermined grain diameter such that the third fired ceramics bodies have predetermined porosity.

It should be noted that the porosity of the third fired ceramics bodies 13 is smaller than that of the first fired ceramics body 11, preferably, is equal to or larger than 2 percent and equal to or smaller than 16 percent, further preferably, is equal to or larger than 2 percent and equal to or smaller than 10 percent.

Furthermore, it is preferable that the porosity of the third fired ceramics bodies 13 is equal to that of the second fired ceramics body 12, however, the porosity of the third fired ceramics bodies 13 may be different from that of the second fired ceramics body 12.

The outer electrode layers 14 are arranged respectively on the outer wall surfaces of the second fired ceramics body 12 where the end portions 10E of the coil 10 protrude therefrom such that the layers 14 contact the end portions 10E of the coil 10 so as to protrude from the outer wall surfaces, respectively. The outer electrode layers 14 are formed by solidifying fluid material (that is, paste) which includes powders of metal such as silver (Ag), etc.

In the coil-buried type inductor 1 shown in the drawings, the conduction is established between the outer electrode layers 14 via the coil 10.

The arrangement of the coil-buried type inductor of the embodiment according to the present invention has been explained above, and the coil-buried type inductor having the above-explained arrangement, has the following advantages.

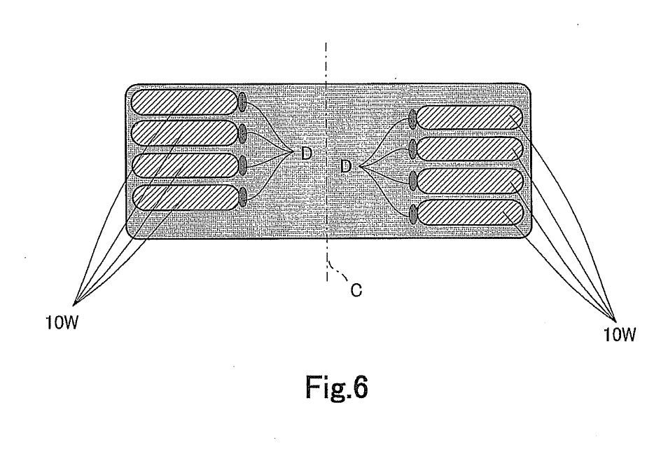

That is, as explained above, the first fired ceramics body 11 is formed by firing the ceramics slurry which includes the ceramics powders as the main component. Therefore, the ceramics slurry shrinks during the firing thereof. In this regard, the first fired ceramics body 11 is arranged so as to surround the generally entire of the coil 10 and therefore the ceramics slurry which will form the first fired ceramics body 11 is arranged so as to surround the generally entire of the coil 10. Therefore, the ceramics slurry inside of the coil 10 (that is, in the generally cylindrical space defined by the wound portions 10W of the coil 10 at the inner periphery side thereof) tends to shrink during the firing thereof in the condition that the ceramics slurry is surrounded by the wound portions 10W of the coil 10). In this regard, the coil 10 is formed by winding the metallic wire material and therefore the coil 10 has a relatively high rigidity. Thus, the shrinkage of the ceramics slurry inside of the coil 10 is inhibited by the coil 10 during the firing thereof. When the shrinkage of the ceramics slurry inside of the coil is inhibited by the coil 10, the cracks (breaks) may be generated at the inner periphery side portion of the wound portions 10W (that is, at the area denoted by reference symbol D in FIG. 6). In this case, the electrical properties of the finally formed coil-buried type inductor may decrease.

However, in the above-explained embodiment according to the present invention, the ceramics slurry inside of the coil 10 includes, as the main component, the ceramics powders of the relatively large grain diameter. Therefore, since the shrinkage ratio thereof is relatively small, even when the shrinkage thereof is inhibited by the coil 10 in some degree, the occurrence of the cracks (breaks) in the part of the fired ceramics body at the inner periphery side portion of the wound portions 10W of the coil can be restricted or at least, the number of the cracks occurring in the part of the fired ceramics body at the inner periphery side portion of the wound portions of the coil 10 is extremely small. Thus, in the above-explained embodiment according to the present invention, the electrical properties of the finally obtained coil-buried type inductor can be favorable.

It should be noted that in the embodiment according to the present invention, the first fired ceramics body 11 has the porosity resulted from forming the first fired ceramics body 11 by firing the ceramics slurry which includes, as the main component, the ceramics powders of the grain diameter such that the occurrence of the cracks in the interior of the first fired ceramics body 11 is restricted or the number of the cracks occurring in the interior of the first fired ceramics body 11 is extremely small when the first fired ceramics body 11 is formed by firing the ceramics slurry. In consideration of this, in the above-explained embodiment according to the present invention, for the first fired ceramics body 11, a fired ceramics body may be employed, which fired ceramics body has the porosity resulted from forming the first fired ceramics body 11 by firing the ceramics slurry which includes, as the main component, the ceramics powders of the grain diameter such that the occurrence of the cracks in the interior of the first fired ceramics body 11 is restricted or the number of the cracks occurring in the interior of the first fired ceramics body 11 is extremely small when the first fired ceramics body ills formed by firing the ceramics slurry. Further, in the above-explained embodiment according to the present invention, for the ceramics powders used to form the first fired ceramics body 11, ceramics powders may be employed, which ceramics powers have the grain diameter such that the occurrence of the cracks in the interior of the first fired ceramics body 11 is restricted or the number of the cracks occurring in the interior of the first fired ceramics body 11 is extremely small when the first fired ceramics body 11 is formed by firing the ceramics slurry.

Further, as explained above, the second fired ceramics body 12 is arranged so as to surround the first fired ceramics body 11. The porosity of the second fired ceramics body 12 is smaller than that of the first fired ceramics body 11. According to this, the following advantages can be obtained. That is, in consideration of the case that the second fired ceramics body 12 is arranged so as not to surround the first fired ceramics body 11, the porosity of the first fired ceramics body 11 is relatively large and therefore when a fluid material (for example, paste or plating solution for forming the outer electrode layers 14) is applied on the outer wall surface of the first fired ceramics body 11 for a certain purpose, the applied material may penetrate into the interior of the first fired ceramics body 11. However, when the fired ceramics body which has the relatively small porosity is employed for the first fired ceramics body 11, the occurrence of the cracks in the fired ceramics body inside of the inner periphery of the wound portions 10W of the coil 10 cannot be restricted or at least the number of the cracks occurring in the fired ceramics body inside of the inner periphery of the wound portions 10W of the coil 10 cannot become small. On the other hand, as in the embodiment according to the present invention, when the second fired ceramics body which has the relatively small porosity is arranged so as to surround the generally cylindrical outer wall surface of the first fired ceramics body 11, the occurrence of the cracks in the fired ceramics body inside of the inner periphery of the wound portions 10W of the coil 10 can be restricted or at least the number of the cracks occurring in the fired ceramics body inside of the inner periphery of the wound portions 10W of the coil 10 can become small as well as the penetration of the fluid material into the interior of the fired ceramics body can be restricted even when the fluid material is applied on the outer wall surface of the fired ceramics body for a certain purpose.

It should be noted that in the above-explained embodiment according to the present invention, the second fired ceramics body 12 has the porosity such that the fluid material is restricted from penetrating into the interior of the second fired ceramics body 12. In consideration of this, in the above-explained embodiment according to the present invention, for the second fired ceramics body 12, the fired ceramics body may be employed, which fired ceramics body has the porosity such that the penetration of the fluid material into the interior thereof is restricted. Further, in the above-explained embodiment according to the present invention, for the ceramics powders used to form the second fired ceramics body 12, the ceramics powders may be employed, which ceramics powders has the grain diameter such that the fired ceramics body which has the porosity can be formed such that the fluid material cannot penetrate into the interior thereof.

Further, as explained above, the third fired ceramics bodies 13 are arranged so as to cover the entire of the outer wall surfaces of the second fired ceramics body 12, respectively, which outer wall surfaces (that is, upper and lower outer wall surfaces 12U and 12L) extend in the direction perpendicular to the central axis of the coil 10. According to this, the following advantages can be obtained. That is, the distance between the upper outer wall surface 12U of the second fired ceramics body 12 and the outer wall surface 11U of the first fired ceramics body 11 is relatively small (the reason that the distance is small, will be explained later), which outer wall surface 11U extends in the direction perpendicular to the central axis C of the coil 10 and is positioned at the upper side of the coil 10 in FIG. 2 (hereinafter, this outer wall surface 11U will be referred to as “upper outer wall surface”). That is, the thickness of the second fired ceramics body 12 adjacent to the upper outer wall surface 11U of the first fired ceramics body 11 is relatively small. Also, the distance between the lower outer wall surface 12L of the second fired ceramics body 12 and the outer wall surface 11L of the first fired ceramics body 11 is relatively small, which outer wall surface 11L extends in the direction perpendicular to the central axis C of the coil 10 and is positioned at the lower side of the coil 10 in FIG. 2. That is, the thickness of the second fired ceramics body 12 adjacent to the lower outer wall surface 11L of the first fired ceramics body 11 is relatively small. Therefore, when the third fired ceramics bodies 13 are not arranged on the upper or lower outer wall surface 12U or 12L of the second fired ceramics body 12 and the fluid material is applied on the upper or lower outer wall surface 12U or 12L, the fluid material may penetrate into the interior of the second fired ceramics body 12 and then reach the first fired ceramics body 11, even when the porosity of the second fired ceramics body 12 is relatively small. Further, since the porosity of the first fired ceramics body 11 is relatively large, the fluid material which reaches the first fired ceramics body 11 may penetrate into the interior of the first fired ceramics body 11 and then reach the coil 10. In this case, as explained above, the electrical properties of the finally formed coil-buried type inductor may decrease.

However, in the above-explained embodiment according to the present invention, the third fired ceramics body 13 is arranged on the upper and lower outer wall surfaces 12U and 12L of the second fired ceramics body 12. Further, since the thicknesses of the third fired ceramics bodies 13 are relatively large, the fluid material cannot reach the second fired ceramics body 12 through the third fired ceramics bodies 13, even when the fluid material is applied on the outer wall surfaces of the third fired ceramics bodies 13. Therefore, the above-explained embodiment according to the invention has an advantage that the favorable electrical properties of the finally formed coil-buried type inductor can be accomplished.

It should be noted that in the above-explained embodiment according to the present invention, the third fired ceramics bodies 13 have the porosity such that the penetration of the fluid material into the third fired ceramics bodies 13 can be restricted. In consideration of this, in the above-explained embodiment according to the present invention, for the third fired ceramics bodies 13, the fired ceramics bodies may be employed, which fired ceramics bodies have the porosity such that the penetration of the fluid material into the interior thereof can be restricted. Further, in the above-explained embodiment according to the present invention, for the ceramics powders used to form the third fired ceramics bodies 13, the ceramics powders may be employed, which ceramics powders have the grain diameter such that the fired ceramics body which has the porosity such that the fluid material cannot penetrate into the interior thereof, can be formed.

It should be noted that in the above-explained embodiment according to the present invention, the transverse cross sectional shape of each of the wound portions 10W of the coil 10 is generally rectangular, however, the shape may be circle or generally circle.

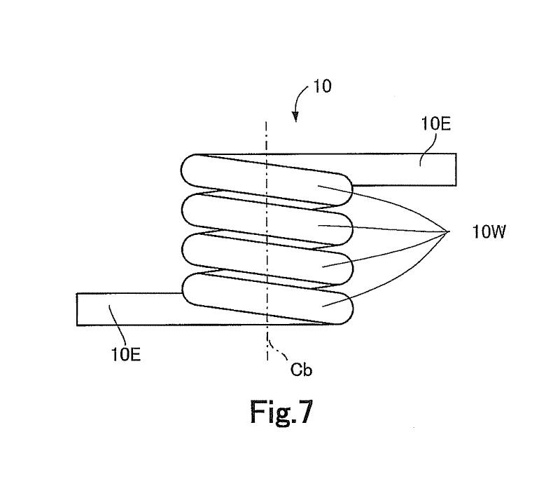

Next, an example of the method for manufacturing the coil-buried type inductor of the embodiment according to the present invention will be explained. First, in the example of the method, a wire material is prepared, which wire material has a circle transverse sectional shape and is coated by a coat made from a ferrite particulate dispersion resin. The resin included in the ferrite particulate dispersion resin is, for example, polyester, the grain diameter of the ferrite particulates included in the ferrite particulate dispersion resin is 0.5 μm, and the ferrite particulates are, for example, added to the ferrite particulate dispersion resin such that the volume percentage thereof becomes 40 volume percent. It should be noted that the particulates other than the ferrite to be dispersed into the resin are preferably silica, particulates or alumina particulates. As shown in FIG. 7, the coil 10 is prepared by helically winding the wire material. The coil 10 has a plurality of wound portions 10W and two end portions 10E.

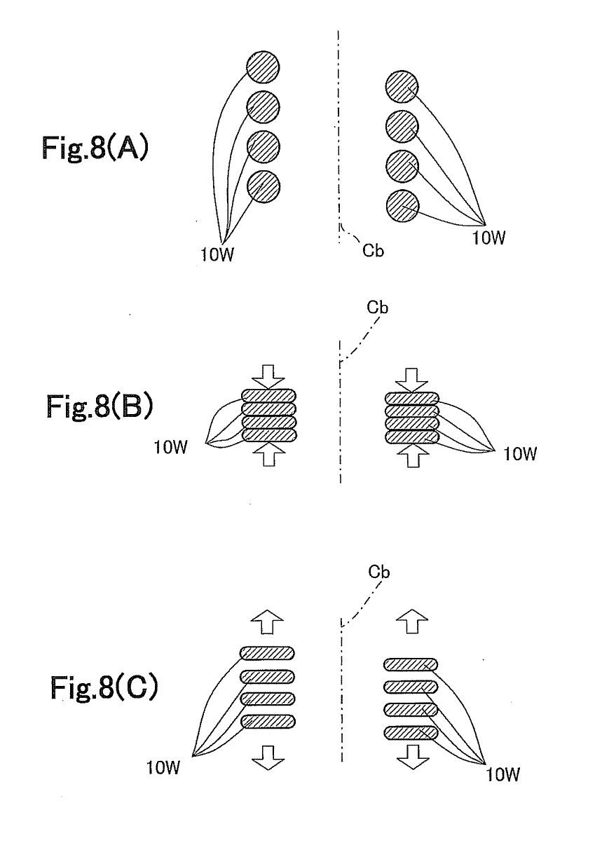

Next, the wound portions 10W are compressed (pressed) in the direction along the central axis Cb of the coil 10 such that the transverse cross sectional shape of each of the wound portions 10W of the prepared coil 10 changes from the circular shape as shown in FIG. 8(A) to the generally rectangular shape as shown in FIG. 8(B). That is, the prepared coil 10 is subject to the so-called impact press or single axis press from the both sides thereof along the direction parallel to the central axis Cb of the coil 10. Therefore, the coil 10 formed of the wire material which has the circle transverse sectional shape as shown in FIG. 7 is changed to the coil 10 formed of the wire material which has the generally rectangular transverse cross sectional shape as shown in FIGS. 3 and 4. Next, as shown in FIG. 8(C), the coil 10 is stretched in the direction parallel to the central axis Cb of the coil such that the pitch between the adjacent wound portions 10W of the coil 10 which has the generally rectangular transverse sectional shape becomes larger than the pitch between the adjacent wound portions 10W of the finally formed coil 10. It should be noted that for the step of making the pitch between the coil wound portions 10W larger than that between the coil wound portions 10W of the finally manufactured coil-buried type inductor, instead of the step of stretching the coil 10 in the direction parallel to the central axis 10b of the coil, a step of pressing the both end portions of the coil 10 while twisting the both end portions of the coil 10 about the central axis of the wire material which constitutes the coil 10 such that the both end portions of the coil 10 approach to each other, can be employed.

On the other hand, independently of preparing the above-explained coil 10, ceramic slurries are prepared to be used to form the first, second and third fired ceramics bodies 11, 12 and 13, respectively. The ceramics slurries are prepared as follows. It should be noted that, the grain diameters of the powders which constitute the ceramics slurries used to form the fired ceramics bodies 11 to 13 are different from each other, however, the methods for forming the ceramics slurries are the same as each other. Therefore, below, only the method for forming the ceramics slurry used to form the first fired ceramics body 11 will be explained.

First, the ceramics powders are prepared. For the ceramics powders, the powders made from the known dielectric material, ferroelectric material, piezoelectric material, magnetic material, etc. can be used, and it is preferable to use the powders made from the dielectric material or magnetic material, depending on the desired properties of the inductor. Among others, the powders made of the manganese-zinc-copper ferrite or nickel-zinc-copper ferrite is preferable since the high frequency properties thereof is accomplished.

The ceramics slurry can be prepared by using the known dispersion medium and the known binder, however, it is preferable to prepare the ceramics slurry which can be subject to the so-called gel casting method.

The gel casting method is a ceramics powder molding technique for forming the non-fluent compact by casting the slurry which includes the ceramics powders and then by hardening or turning into a gel the slurry by heat. The slurry may be hardened or turned into a gel not by heat. The gel casting method has a feature that the shrinkage is small upon molding, since the dispersion medium vaporizes after the slurry loses its fluidity. Therefore, in the case that the gel casting method is used to bury the coil which has the large rigidity in the ceramics compact, the damages such as the cracks by the shrinkage upon molding is restricted.

The slurry used to form the ceramics compact by the gel casting method is prepared by adding hardening agent, gelatinizing agent, etc. to the dispersion medium where the ceramics powders are dispersed therein. The hardening agent (the gelatinizing agent) includes precursor of hardened resin (resin gel) and hardening initiator/promoter (gelling initiator/promoter) for initiating or promoting the hardening (gelling) of the precursor of the hardened resin. It is desirable that the addition such as the hardening agent, gelatinizing agent, etc. is uniformly mixed.

The dispersion medium is selected from the group of water, nonpolar organic solvent, polar organic solvent, etc. As the organic solvent selected for the dispersion medium, there are lower alcohol such as methanol, ethanol, isopropyl alcohol, etc., higher alcohol, acetone, hexane, benzene, toluene, diols such as ethylene glycol, etc., triols such as glycerin, etc., polybasic acid ester such as glutaric acid dimethyl, etc., esters having two or more ester groups such as triacetin, etc., polyester compound such as polycarboxylate, etc, phosphate ester, amine condensate, nonionic special amide compound, etc. The dispersion medium may be any of pure substance and mixture.

The resin which constitutes the resin hardening agent is selected from the group of epoxy resin, acrylic resin, urethane resin, etc. The resin is selected from the group of substances which have a high compatibility with and low reactivity to the dispersion medium. For the epoxy resin, the polymer is selected, which polymer includes the constitutive monomer such as ethylene glycol diglycidyl ether, polyethylene glycol diglycidyl ether, propylene glycol diglycidyl ether, polypropylene glycol, glycerin diglycidyl ether, etc. For the acrylic resin, the polymer is selected, which polymer includes the constitutive monomer such as acrylamide, methacrylic acid, N-hydroxymethyl acrylamide, acrylic acid ammonium solt, etc. For the urethane resin, the polymer is selected, which polymer includes the constitutive monomer such as MDI (4,4′-diphenylmethane diisocyanate)-based isocyanate, HDI (hexamethylene diisocyanate)-based isocyanate, TDI (tolylene diisocyanate)-based isocyanate, IPDI (isophorone diisocyanate)-based isocyanate, isothiocynanate, etc.

The hardening initiator/promoter is selected in consideration of the reactivity thereof to precursor of the hardened resin. Further, the hardening initiator/promoter is selected from the group of polymers such as polyalkylen polyamine such as tetramethylethylenediamine, triethylendiamine, hexanediamine, ethylenediamine, etc., piperazines such as 1-(2-aminoethyl) piperazine, etc., polyetheramine such as polyoxyethylenediamine, etc., N,N′-methylenebisacrylamide, 6-dimethylamino-1-hexanol, ammonium persulfate, hydrogen peroxide, etc.

A dispersion agent such as carboxylic acid copolymer, acrylic acid copolymer, etc. may be added in order to improve the dispersibility or catalyst such as 6-dimethylamino-1-hexanol, etc. may be added in order to promote the reaction of the hardening (gelation). The ceramics powders may include addition such as sintering aid, etc.

Concretely, the ceramics slurry which is the material for forming the fired ceramics body 11 can be obtained by mixing 20 to 40 parts by weight (in the present example, 27 parts by weight) of glutaric acid dimethyl and 2 to 4 parts by weight (in the present example, 3 parts by weight) of triacetin for the dispersion medium and 1 to 5 parts by weight (in the present example, 2 parts by weight) of carboxylic acid copolymer for the dispersion agent and thereafter by adding thereto 1 to 10 parts by weight (in the present example, 6.4 parts by weight) of 4,4′-diphenylmethane diisocyanate and 0.05 to 2.7 parts by weight (in the present example, 0.35 parts by weight) of ethylene glycol for the gelatinizing agent, 0.03 to 2 parts by weight (in the present example, 0.06 parts by weight) of 6-dimethylamino-1-hexanol for the reaction catalyst and 0.01 to 1 parts by weight (in the present example, 0.25 parts by weight) of water, relative to 100 parts by weight of the ceramics powders.

Otherwise, the ceramics slurry which is the material for forming the fired ceramics body 11 can be obtained by mixing 1 to 10 parts by weight (in the present example, 2 parts by weight) of ethanol and 10 to 30 parts by weight (in the present example, 25 parts by weight) of ion-exchange water for the dispersion medium and 1 to 5 parts by weight (in the present example, 2 parts by weight) of carboxylic acid copolymer for the dispersion agent and thereafter by adding thereto 1 to 10 parts by weight (in the present example, 5 parts by weight) of polypropylene glycol diglycidyl ether and 0.5 to 5 parts by weight (in the present example, 1 parts by weight) of 1-(2-aminoethyl) piperazine for the gelatinizing agent, relative to 100 parts by weight of the ceramics powders.

Otherwise, the ceramics slurry which is the material for forming the fired ceramics body 11 can be obtained by mixing 20 to 50 parts by weight (in the present example, 35 parts by weight) of ion-exchange water for the dispersion medium and 1 to 5 parts by weight (in the present example, 2.5 parts by weight) of carboxylic acid copolymer for the dispersion agent and thereafter, by adding thereto 4 to 10 parts by weight (in the present example, 6 parts by weight) of methacrylic amide, 0.1 to 1 parts by weight (in the present example, 0.3 parts by weight) of N,N′-methylenebisacrylamide, 0.01 to 0.1 parts by weight (in the present example, 0.02 parts by weight) of N,N,N′,N′-tetramethylethylenediamine and 0.01 to 0.1 parts by weight (in the present example, 0.02 parts by weight) of ammonium persulfate for gelatinizing agent, relative to 100 parts by weight of the ceramics powders.

Next, the plate-like ceramics compacts (hereinafter, this compacts will be referred to as “third ceramics compacts”) are formed, which third ceramic compacts finally become the third fired ceramics bodies 13. The third ceramics compacts are formed as follows.

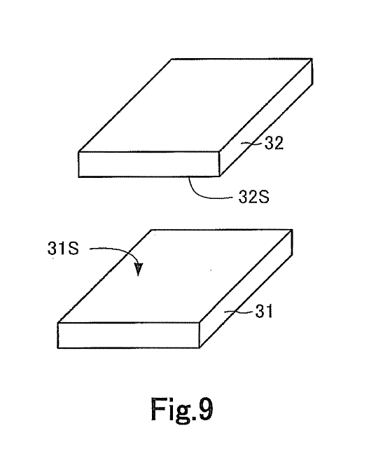

That is, first, as shown in FIG. 9, first and second shaping molds 31 and 32 are prepared, which shaping molds are stainless (for example, aluminum alloy such as duralumin, etc.) parallelepiped plates. Next, non-adherent coats are formed on the surfaces 31S and 32S (hereinafter, these surfaces will be referred to as “molding surfaces”) of the first and second shaping molds 31 and 32 by applying mold release agent on the molding surfaces 31S and 32S. It should be noted that the coats are formed in order to facilitate the release of the ceramics compact formed on the molding surfaces 31S and 32S therefrom. Further, for the coats, for example, several kinds of coats may be used, which coats may be composed of fluorine resin, silicon resin, fluorine oil, silicon oil, plating, coats by CVD, PVD, etc. It should be noted that in the case that fluorine resin, silicon resin, fluorine oil, or silicon oil is used for the coating material, the coats are formed by the spraying, the dipping, etc.

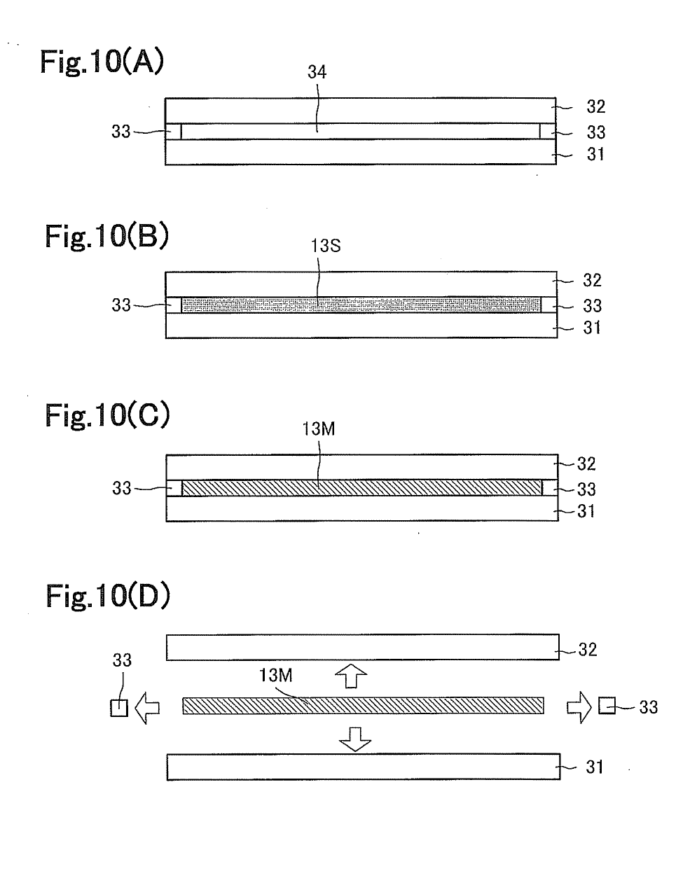

Next, as shown in FIG. 10(A), the first and second shaping molds 31 and 32 are set such that spacers 33 are nipped between the shaping molds and the molding surfaces 31S and 32S of the first and second shaping molds 31 and 32 are oppositely positioned. It should be noted that the dimensions of the spacers 33 are set such that the distance between the molding surfaces 31S and 32S of the first and second shaping molds 31 and 32 corresponds to the thickness of the finally formed third fired ceramics body 13. Further, the shape of the space 34 defined by the first and second shaping molds 31 and 32 and the spacers 33 corresponds to the shape of the finally obtained third fired ceramics body 13.

Next, as shown in FIG. 10(B), the ceramics slurry 13S formed as explained above is filled in the space 34 defined by the first and second shaping molds 31 and 32 and the spacers 33. Next, as shown in FIG. 10(C), the ceramics slurry 13S filled in the space 34 is left for 10 to 30 hours (in the present example, 15 hours) to be solidified (hardened) and therefore the third ceramics compact 13M is formed.

Next, as shown in FIG. 10(D), the first and second shaping molds 31 and 32 and the spacer 33 are removed from the third ceramics compact 13M formed as explained above and therefore the third ceramics compact 13M is obtained. In this embodiment, the two ceramics compacts 13M are prepared as explained above.

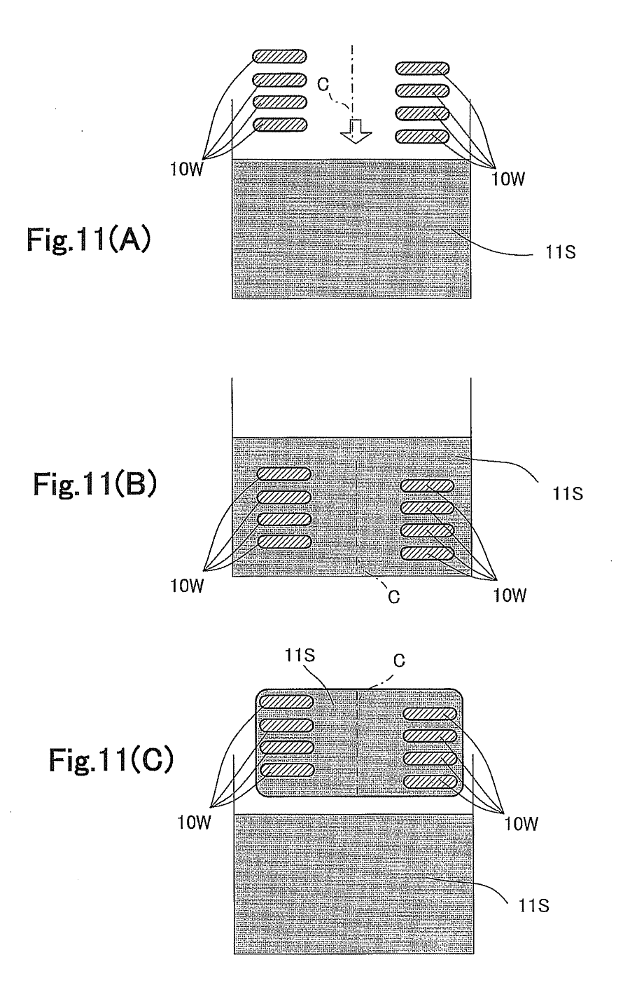

On the other hand, as shown in FIGS. 11(A) to 11(C), the coil 10 stretched as explained above is dipped in the first ceramics slurry 11S formed as explained above and thereafter the coil is removed from the first ceramics slurry 11S. Thereby, the first ceramics slurry 11S is arranged so as to surround the coil 10. Next, the first ceramics slurry 11S which surrounds the coil 10 is left as it is (for example, for 24 hours) to gel. Therefore, an unfired ceramics compact (hereinafter, this compact will be referred to as “first ceramics compact”) is formed, which first ceramics compact will become the first fired ceramics body 11 later by the firing. It should be noted that as explained above, the first ceramics slurry 11S used here includes, as the main component, the ceramics powder of the relatively large grain diameter.

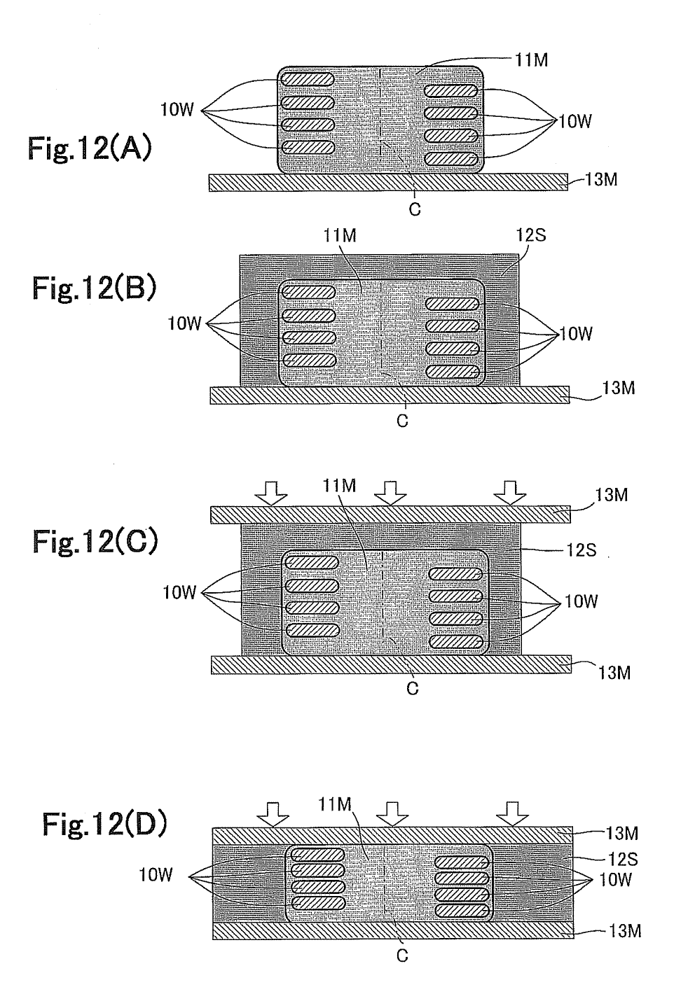

Next, as shown in FIG. 12(A), the coil 10 where the first ceramics compact 11M formed as explained above is arranged therearound, is positioned on one of the plate-like third ceramics compacts 13M prepared as explained above. It should be noted that as explained above, the third ceramics slurry used to form the third ceramics compacts used here includes, as the main component, the ceramics powders of the relatively small grain diameter and the third ceramics compacts have the relatively small porosity.

Next, as shown in FIG. 12(B), the second ceramics slurry 12S is arranged so as to surround the first ceramics compact 11M which is arranged so as to surround the coil 10 positioned on the third ceramics compact 13M. It should be noted that as explained above, the second ceramics slurry 12S used here includes, as the main component, the ceramics powders of the relatively small grain diameter.

Next, as shown in FIGS. 12(C) and 12(D), the other plate-like third ceramics compact 13M prepared as explained above is pressed against the second ceramics slurry 12S such that the other third ceramics compact 13M nips the second ceramics slurry 12S in cooperation with the third ceramics compact 13M where the coil 10 is already positioned thereon and the pitch between the adjacent wound portions 10W of the coil 10 becomes equal to that between the adjacent wound portions 10W of the finally formed coil 10, while the condition that the both end portions 10E of the coil 10 protrude from the second ceramics slurry 12S, is maintained. It should be noted that as explained above, the third ceramics slurry used to form the third ceramics compacts used here includes, as the main component, the ceramics powders of the relatively small grain diameter and the third ceramics compacts have the relatively small porosity.

Next, the second ceramics slurry 12S which surrounds the first ceramics compact 11M, is left as it is (for example, for 24 hours) to gel. Therefore, the unfired ceramics compact (hereinafter, this compact will be referred to as “second ceramics compact”) is formed, which second ceramics compact will become the second fired ceramics body 12 later by the firing.

Next, the first and second ceramics compacts 11M and 12M which gel as explained above, are left at relatively high temperature (for example, 130° C.) (for example, for 4 hours) to be dried.

Next, the first and second ceramics compacts 11M and 12M which are formed as explained above, as well as the third ceramics compacts 13M are fired at the high temperature and therefore the first, second and third fired ceramics bodies 11, 12 and 13 are formed.

The firing is performed as follows. The surrounding temperature is increased from the ambient temperature to the first holding temperature at the rate of temperature increase of 10 to 100° C./h and thereafter the surrounding temperature is maintained the first holding temperature for 1 hour to 5 hours. Next, the surrounding temperature is increased to the second holding temperature at the rate of temperature increase of 10 to 100° C./h and thereafter the surrounding temperature is maintained at the second holding temperature for 1 hour to 5 hours. Next the surrounding temperature is increased to the highest holding temperature at the rate of temperature increase of 500 to 3000° C./h and thereafter the surrounding temperature is maintained at the highest holding temperature for 1 hour to 5 hour. Next, the surrounding temperature is decreased to the ambient temperature at the rate of temperature increase of 50 to 500° C./h. It is preferable that the first holding temperature is 150 to 300° C., the second holding temperature is 400 to 600° C. and the highest holding temperature is 880 to 950° C. Further, the holding of the surrounding temperature at the first holding temperature may be omitted.

The first fired ceramics body 11 which is formed as explained above, has the relatively large porosity, the second fired ceramics body 12 which is formed as explained above, has the relatively small porosity and the third fired ceramics bodies 13 which are formed as explained above, have the relatively small porosity.

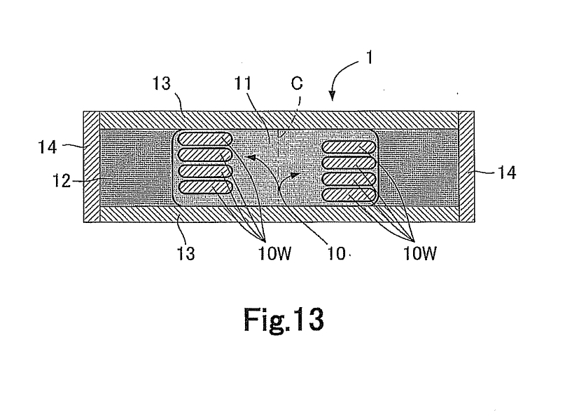

Next, as shown in FIG. 13, the outer electrode layers 14 are arranged on the outer wall surfaces of the second fired ceramics body 12 such that the outer electrode layers 14 contact the both end portions 10E of the coil 10. Therefore, the above-mentioned coil-buried type inductor of the embodiment according to the present invention is formed.

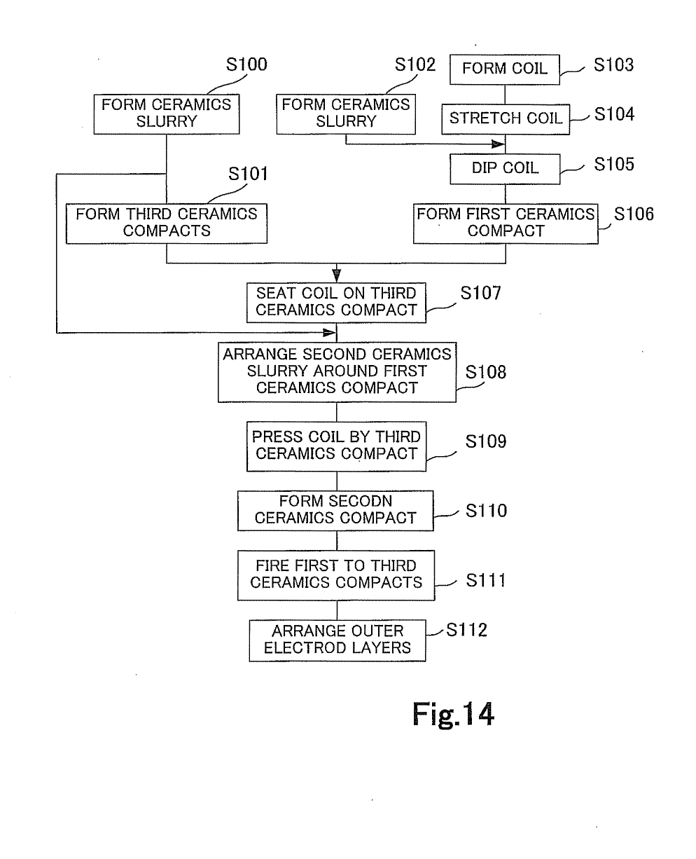

FIG. 14 briefly shows the flow of the method for manufacturing the above explained coil-buried type inductor of the embodiment. That is, at the step S100, the ceramics slurry is formed, which ceramic slurry will be used to form the second and third fired ceramics bodies 12 and 13. Next, at the step S101, the third ceramics compacts are formed by using the ceramics slurry formed at the step S100, which third ceramics compacts will become the third fired ceramics bodies later by the firing. On the other hand, at the step S102, the ceramics slurry is formed, which ceramics slurry will be used to form the first fired ceramics body 11.

Further, at the step S103, the coil 10 is formed, which coil will be buried in the coil-buried type inductor. Next, at the step S104, the coil 10 formed at the step S103 is stretched in the direction parallel to the central axis of the coil such that the pitch between the adjacent wound portions 10W of the coil becomes larger than the predetermined value. Next, at the step S105, the coil 10 stretched at the step S104 is dipped in the ceramics slurry formed at the step S102 and thereby the first ceramics slurry 11S is arranged around the coil 10. Next, at the step S106, the first ceramics slurry 11S arranged around the coil 10 at the step S105 is hardened and thereby the first ceramics compact 11M is formed around the coil 10.

Next, at the step S107, the coil 10 where the first ceramics compact 11M is arrange therearound at the step S106, is seated on the lower third ceramics compact 13M formed at the step S101. Next, at the step S108, the ceramics slurry formed at the step S100 is arranged as the second ceramics slurry 12S around the first ceramic compact 11M which is arranged around the coil 10 and is seated on the lower third ceramics compact 13M at the step S107. Next, at the step S109, the coil 10 which is seated on the lower third ceramics compact 13M as well as the first ceramics compact 11M which is arranged around the coil and the second ceramics slurry 12S are pressed by the upper third ceramics compact 13M formed at the step S101. Next, at the step S110, the second ceramics slurry 12S which is pressed by the upper third ceramics compact 13M at the step S109, is hardened and thereby the second ceramics compact 12M is formed around the first ceramics compact 11M. Next, at the step S111, the second ceramics compact 12M which is obtained by the hardening at the step S110 as well as the first ceramic compact 11M and the third ceramics compacts 13M which are positioned at the upper and lower sides of the second ceramics compact, are fired and therefore the first, second and third fired ceramics bodies 11, 12 and 13 are formed. Next, at the step S112, the outer electrode layers 14 are arranged on the second fired ceramics body 12 which is obtained by the hardening at the step S111.

It should be noted that in the above-explained embodiment according to the present invention, the ceramics slurry which include, as the main component, the ceramics powders of the large grain diameter, is used to form the first fired ceramics body which has the relatively large porosity. However, instead of this, the ceramics slurry may be used, which ceramics slurry includes, as the main component, the ceramics powders of the relatively small grain diameter and the relatively large amount of beads or binder which can be removed by the burning thereof upon the firing.

Further, in the above-explained embodiment according to the present invention, the wire material which forms the coil 10, has the generally rectangular transverse cross sectional shape which is elongated in the direction perpendicular to the central axis C of the coil 10. Therefore, the transverse cross sectional area of the coil 10 can be maintained constant while the length of the coil 10 in the direction along the central axis 10 of the coil 10 can be short. Thus, the length of the coil 10 of the finally obtained coil-buried type inductor in the direction along the central axis C can be short. That is, the thickness of the coil 10 of the finally obtained coil-buried type inductor in the direction along the central axis C can be small.

In the above-explained embodiment, the coil which is formed of the wire material which has the circle transverse cross sectional shape, is used to form the coil which is formed of the wire material which has the generally rectangular transverse cross sectional shape. However, the coil which is formed of the wire material which has the transverse cross sectional shape other than the generally circle cross sectional shape, may be used, when the coil which is formed of the wire material which has the generally rectangular transverse cross sectional shape, is finally formed. Of course, the coil which is formed of the wire material which has the generally rectangular transverse cross sectional shape, may be formed by preparing the wire material which has the generally rectangular transverse cross sectional shape and then helically winding the wire material. Further, in the above-explained embodiment, the coil which is formed of the wire material which has the generally rectangular transverse cross sectional shape, is used. However, the coil which is formed of the wire material which has the transverse cross sectional shape other than the generally rectangular transverse cross sectional shape, for example, the polygonal transverse cross sectional shape such as the square, hexagonal, trapezoid transverse cross sectional shape, etc., the transverse cross sectional shape which is obtained by rounding the corners of the polygonal shape, the ellipitical transverse cross sectional shape, the oval transverse cross sectional shape, the track-like transverse cross sectional shape (that is, the semicircles are added to the short sides of the rectangle, the diameter of the semicircles corresponding to the length of the short side of the rectangle), can be used.

The fifteen kinds of fifty number of the coil-buried type inductors were manufactured such that the inductors have the dimensions shown in the following Table 1 according to the above-explained embodiment according to the present invention while the combination of the porosities of the first, second and third fired ceramics bodies was variously changed and the electrical properties of the inductors were analyzed. The result of the analysis is shown in the following Table 2.

It should be noted that in the Table 1, the pitch between coil wound portions is the pitch between the adjacent wound portions of the coil buried in the finally obtained coil-buried type inductor, the wire material thickness is the thickness of the wire material which constitutes the coil measured in the direction parallel to the central axis of the coil, the ceramics compact thickness between coil wound portions is the thickness of the ceramics compact filled between the adjacent wound portions of the coil measured in the direction parallel to the central axis of the coil, the coil winding number is the number of the winding of the wire material which constitutes the coil, the total wire material thickness is the total thickness of all wound portions measured in the direction parallel to the central axis of the coil, the ceramics compact plate thickness is the total thickness of the upper and lower ceramics compact plates measured in the direction parallel to the central axis of the coil, and the inductor thickness is the thickness of the unfired coil-buried type inductor before the finally obtained coil-buried type inductor measured in the direction parallel to the central axis of the coil.

Further, the coil-buried type inductors are manufactured from the first to third fired ceramics bodies which are nickel-zinc-copper ferrites. Further, for the powders which are the main component of the ceramics slurry used to form the first fired ceramics body, the powders which have specific surface area converted grain diameter of 0.3 to 0.5 μm (specific surface area of 2.2 to 3.7 m²/g), are used and for the powders which are the main component of the ceramics slurry used to form the second and third fired ceramics bodies, the powders which have specific surface area converted grain diameter of 0.1 to 0.25 μm (specific surface area of 4.4 to 11.0 m²/g), are used. The specific surface area converted grain diameter is calculated by using the measured specific surface area of the particulates and the relation of 6/(density×specific surface area) assumed that the density is 5.4.

The powders can be prepared as follows. First, Fe₂O₃, ZnO, NiO and CuO are weighed, respectively and thereafter they are mixed. For the method of the mixing, the wet or dry mixing which uses the ball mill or the beads mill is used and the time duration for the mixing may be 1 hour to 10 hours. After the mixing, the mixture is dried and thereafter is sieved and thereby the powders are obtained.

Next, the thus obtained powders are heat treated, that is, are pre-fired. It is preferable that the temperature of the pre-firing is lower than that which the ferrite haploidization occurs by 50 to 200° C., for example, is within the range of 600 to 800° C. It is preferable that the time duration for the pre-firing is 1 hour to 3 hours.

The thus pre-fired powders are milled, for example, by the ball mill for 10 to 80 hours such that the desired specific surface area (grain diameter) can be obtained. For the method of the milling, the known method such as the ball mill, beads mill, etc. can be used. Thereafter, the milled powders are dried and thereafter are sieved and therefore the ferrite particulates are obtained.

Further, the first, second and third fired ceramics bodies are formed by hardening the first, second and third ceramics slurry according to the above-explained embodiment according to the present invention and then firing the first, second and third ceramics compacts obtained by the hardening according to the above-explained rate of the temperature increase and the holding temperature.

Further, the plating solution is applied on the outer wall surfaces of the finally obtained coil-buried type inductors.

Further, in the Table 2, the crack occurrence rate is the ratio of the number of the coil-buried type inductors where the cracks (breaks) occur in the interior of the manufactured coil-buried type inductors relative to the number (in the present example, fifty) of all manufactured coil-buried type inductors, the defective occurrence rate by interior penetration is the ratio of the number of the coil-buried type inductors where the defective of the electrical properties occurs directly due to the reaching of the plating solution applied on the outer wall surfaces of the manufactured coil-buried type inductor to the coil buried in the interior of the coil-buried type inductor through the first to third fired ceramics bodies, relative to the number of the manufactured coil-buried type inductor where no crack occurs, and the electrical property defective occurrence rate is the ratio of the number of the coil-buried type inductors where the defective of the electrical properties occur directly due to the porosity of the first fired ceramics body of the manufactured coil-buried type inductor, relative to the number of the manufactured coil-buried type inductors where no crack occurs and no defective by the interior penetration occurs. It should be noted that it is judged that the defective of the electrical properties of the coil-buried type inductor occurs in the case that the inductance of the manufactured coil-buried type inductor is out of the range of 2.4 to 3.6 μH.

Further, regarding the comparative examples 2-1 to 2-3 of the Table 2, in the column of the defective occurrence rate by interior penetration and the electrical property defective occurrence rate, the symbol “-” means that the analysis of the defective occurrence rate by interior penetration and the electrical property defective occurrence rate is omitted, since the crack occurrence rate is 100 percent and therefore it is judged that the defective occurrence rate by interior penetration and the electrical property defective occurrence rate are extremely large (probably, 100 percent), and regarding the comparative example 4-1 of the Table 2, in the column of the electrical property defective occurrence rate, the symbol “-” means that the analysis of the electrical property defective occurrence rate is omitted, since the defective occurrence rate by interior penetration is 100 percent and therefore it is judged that the electrical property defective occurrence rate is extremely large.

TABLE 1

| | |
|---|---|
| Pitch between coil wound portions (μm) | 110 |
| Wire material thickness (μm) | 50 |
| Wire material width (μm) | 300 |
| Ceramics compact thickness between coil wound portions (μm) | 60 |
| Coil winding number (turn) | 5.25 |
| Total wire material thickness (μm) | 300 |
| Ceramics compact plate thickness (μm) | 500 |
| Inductor thickness (μm) | 1160 |

TABLE 2

| | | | | Defective | Electrical |
|---|---|---|---|---|---|
| | Porosity of | Porosity of | Crack | occurence rate | property |
| | first ceramics | second and third | occurence | by interior | defective |
| | fired body | ceramics fired | rate | penetration | occurence |
| | (%) | bodies (%) | (%) | (%) | rate (%) |
| Example 1-1 | 40 | 2 | 4 | 0 | 2 |
| Example 1-2 | 40 | 10 | 4 | 2 | 2 |
| Example 1-3 | 40 | 16 | 4 | 6 | 2 |
| Example 1-4 | 50 | 2 | 2 | 0 | 4 |
| Example 1-5 | 50 | 10 | 2 | 2 | 4 |
| Example 1-6 | 50 | 16 | 2 | 6 | 4 |
| Example 1-7 | 60 | 2 | 0 | 0 | 10 |
| Example 1-8 | 60 | 10 | 0 | 2 | 10 |
| Example 1-9 | 60 | 16 | 0 | 6 | 11 |
| Comparative | 30 | 2 | 100 | — | — |
| example 2-1 | | | | | |
| Comparative | 30 | 16 | 100 | — | — |
| example 2-2 | | | | | |
| Comparative | 30 | 20 | 100 | — | — |
| example 2-3 | | | | | |
| Comparative | 70 | 2 | 0 | 0 | 100 |
| example 3-1 | | | | | |
| Comparative | 70 | 16 | 0 | 6 | 100 |
| example 3-2 | | | | | |
| Comparative | 50 | 20 | 4 | 100 | — |
| example 4-1 | | | | | |

As can be understood from the Table 2, in the case that the porosity of the first fired ceramics body is equal to or larger than 40 percent (the examples 1-1 to 1-9 and the comparative examples 3-1, 3-2 and 4-1), independently of the porosities of the second and third fired ceramics bodies, the crack occurrence rate is relatively small (0 to 4 percent). However, even when the crack occurrence rate is relatively small, in the case that the porosities of the second and third fired ceramics bodies are equal to or larger than 20 percent, the defective occurrence rate by interior penetration is extremely large (100 percent). Therefore, in the case that the porosity of the first fired ceramics body is equal to or larger than 40 percent and the porosities of the second and third fired body are smaller than 20 percent (the examples 1-1 to 1-9 and the comparative examples 3-1 and 3-2), the crack occurrence rate and the defective occurrence rate by interior penetration are relatively small. However, even when the crack occurrence rate and the defective occurrence rate by interior penetration are relatively small, in the case that the porosity of the first fired ceramics body is equal to or larger than 70 percent (in the comparative example 3-1 and 3-2), the electrical property defective occurrence rate is extremely large (100 percent). Therefore, in the case that the porosity of the first fired ceramics body is equal to or larger than 40 percent and is smaller than 70 percent and the porosities of the second and third fired ceramics bodies is equal to or larger than 2 percent and is smaller than 20 percent (in the examples 1-1 to 1-9), the crack occurrence rate, the defective occurrence rate by interior penetration and the electrical property defective occurrence rate is relatively small.

It should be noted that the contents of the Japanese Patent Application No. 2009-219611 is incorporated in this application by reference.

1. A coil-buried type inductor comprising:
a conductive coil;
a first fired ceramics body arranged in an area surrounding the coil and at least along an inner periphery of the coil; and
a second fired ceramics body arranged so as to surround the entire of the coil along with the first fired ceramics body; and
wherein the first fired ceramics body has porosity equal to or larger than 40 percent and smaller than 70 percent.

2. The coil-buried type inductor as set forth in claim 1, wherein the porosity of the first fired ceramics body is larger than that of the second fired ceramics body.

3. The coil-buried type inductor as set forth in claim 1, wherein the first fired ceramics body is arranged in the entire of the area defined by the inner periphery of the coil.

4. The coil-buried type inductor as set forth in claim 1, wherein a fluid material is applied on an outer wall surface of the second fired ceramics body and the porosity of the second fired ceramics body is such that the fluid material cannot penetrate into an interior of the second fired ceramics body.

5. The coil-buried type inductor as set forth in claim 1, wherein the transverse cross sectional shape of the coil is generally rectangular.

6. A method for manufacturing a coil-buried type inductor comprising a conductive coil, a first fired ceramics body arranged in an area surrounding the coil and at least along an inner periphery of the coil and a second fired ceramics body arranged so as to surround the entire of the coil along with the first fired ceramics body,
wherein the method comprises:
a step of preparing a conductive coil;
a step of arranging a first ceramics slurry in the area surrounding the coil and at least along the inner periphery of the coil, the first ceramics slurry including, as the main component, ceramics powders of predetermined grain diameter, and hardening the first ceramics slurry to form a first ceramics compact;
a step of arranging a second ceramics slurry so as to surround the entire of the coil along with the first ceramic compact, the second ceramics slurry including, as the main component, ceramics powders of the grain diameter smaller than that of the ceramics powders constituting the first ceramics slurry; and
a step of firing the first and second slurries to form the first and second fired ceramics bodies, respectively.

7. The method as set forth in claim 6, wherein at the step of arranging the first ceramics slurry in the area along the inner periphery of the coil, the first ceramics slurry is arranged in the entire of the area defined by the inner periphery of the coil.

8. The method as set forth in claim 6, wherein the step of preparing the coil includes a step of preparing the coil which has wound portions which are wound at a pitch larger than a predetermined value;
wherein the method further comprises:
a step of hardening a third ceramics slurry to form two plate-like ceramics compacts, the third ceramics slurry including, as the main component, ceramics powders of the grain diameter smaller than that of the ceramics powders constituting the first ceramics slurry; and
a step of positioning the coil along with the first ceramics compact and the second ceramics slurry between the two plate-like ceramics compacts and pressing the coil along with the first ceramics compact and the second ceramics slurry in the direction parallel to the central axis of the coil such that the pitch between the adjacent wound portions becomes the predetermined value after the step of arranging the second ceramics slurry so as to surround the entire of the coil along with the first ceramics compact and before the step of forming the first and second fired ceramics bodies; and
wherein the step of forming the first and second fired ceramics bodies includes a step of firing the two plate-like ceramics compacts to form third fired ceramics bodies.

9. The method as set forth in claim 6, wherein the method further comprises a step of applying a fluid material on the outer wall surface of the second fired ceramics body, and wherein the second ceramics slurry is a ceramics slurry which includes, as the main component, ceramics powders of the grain diameter producing the porosity of the second fired body such that the fluid material cannot penetrate into the interior of the second fired ceramics body.

10. The method as set forth in claim 9, wherein the method further comprises a step of applying a fluid material on the outer wall surfaces of the third fired ceramics bodies; and wherein the ceramics slurry used to form the two plate-like ceramics compacts is a ceramics slurry which includes, as the main component, ceramics powders of the grain diameter producing the porosity of the third fired ceramics bodies equal to that of the second fired ceramics body.

11. The method as set forth in claim 6, wherein the transverse cross sectional shape of the coil is generally rectangular.
